(19) United States
(12) Patent Application Publication
(10) Pub. No.: US 2009/0175702 A1
(43) Pub. Date: Jul. 9, 2009

(54) HIGH TORQUE TRANSMISSION FASTENER AND SOCKET THEREFOR

(75) Inventor: Chao-Wei Lin, Tainan City (TW)

Correspondence Address: CHOATE, HALL & STEWART LLP, TWO INTERNATIONAL PLACE, BOSTON, MA, 02110, US

(73) Assignee: Kwantex Research Inc., Tainan Hsien (TW)

(21) Appl. No.: 12/349,243

(22) Filed: Jan. 6, 2009

(30) Foreign Application Priority Data
Jan. 8, 2008 (TW) 097100706

(51) Int. Cl. F16B 25/00; B25B 23/00

(52) U.S. Cl. 411/386; 81/438

(57) ABSTRACT

A fastener includes a driven head and a shank portion. The driven head has a top end, a bottom end, a plurality of flat guide surfaces connected between the top and bottom ends, a plurality of angularly spaced-apart rounded driven lobes each connected between two adjacent flat guide surfaces, and a flanged abutment section projecting outwardly and radially from the bottom end. Each flat guide surface is indented between two adjacent rounded driven lobes. The shank portion is connected to the driven head, and has a thread extending helically around an outer periphery of the shank portion.

### CROSS-REFERENCE TO RELATED APPLICATION

This application claims priority of Taiwanese Application No. 097100706, filed on Jan. 8, 2008, which is incorporated herein by reference in its entirety.

BACKGROUND OF THE INVENTION

1. Field of the Invention

This invention relates to a fastener, more particularly to a high torque transmission fastener and a socket therefor.

2. Description of the Related Art

Two conventional screws 1, 1′ are respectively illustrated in FIGS. 1 and 2. Each of the conventional screws 1, 1′ includes a head portion 11, 11 ′ having a slightly rounded top end face, and a threaded shank portion 12, 12′ extending outwardly from a bottom end of the head portion 11, 11′. The head portions 11, 11′ of the screws 1, 1′, as shown respectively in FIGS. 3 and 4, have a square shape. Each conventional screw 1, 1′ is driven to rotate by a socket 13 which is sleeved on the head portion 11, 11′ of the respective screw 1, 1′.

Since the head portion 11, 11′ of each conventional screw 1, 1′ is square-shaped, the continuous forces on bearing surfaces 14 (see FIG. 3) of the head portion 11, 11′ by the socket 13 when tightening the screw 1, 1′ results in wearing of corner angles of the head portion 11, 11′. And, the head portion 11, 11′ normally wears out when socket 13 turns the head portion 11, 11′, which strips the corners of the head portion 11, 11′. With continued wear, the socket 13 may slip when applying a torque to the head portion 11, 11′, so that torsional energy for turning the screw 1, 1′ is lost. Further, since the socket 13 is sleeved on the head portion 11, 11′ through the receiving groove 131, and has an outer portion extending outwardly from the head portion 11, 11′ so that it occupies a space outside of the head portion 11, 11′, the usability of the conventional screw 1, 1′ is limited due to the additional space required to accommodate the socket 13.

Another two conventional screws (1a, 1b) are respectively illustrated in FIGS. 5 and 6. Each screw (1a, 1b) has a head portion (11a, 11b), a shankportion (12a, 12b), and a flanged portion 111 between the head and shank portions (11a, 11b, 12a, 12b). Each of the head portions (11a, 11b) of the screws (1a, 1b) has a hexagonal cross section, and an indentation 113 (see also FIGS. 7 and 8). Through the presence of the flanged portion 111 of each screw (1a, 1b), when a socket 13 is sleeved on the head portion (11a, 11b), the socket 13 abuts against the flanged portion 111, so that the socket 13 does not occupy a space outside of the screw (1a, 1b). Further, because the screw (1a, 1b) has six bearing surfaces 14 (see FIG. 7), the socket 13 contacts the screw (1a, 1b) over a relatively large area to minimize wear. Nevertheless, the six corner angles of the screw (1a, 1b) still wear over time, so that after prolonged use, slippage of the socket 13 when applying a torque to the screw (1a, 1b) is likely to occur. Thus, torsional energy for turning the screw (1a, 1b) is similarly lost.

FIGS. 9 and 10 illustrate still another conventional screw (1c), which includes a flanged portion 111, and an indentation 113 formed in the head portion (11c). The head portion (11c) has a corrugated peripheral structure. When the socket 13 is sleeved on the head portion (11c) with numerous bearing surfaces, the increases of driven torque transferred from the head portion (11c) allows the socket 13 to apply more torque to the screw (1c), so that stripping of the head portion (11c) is minimized. However, it is difficult to make the head portion (11c) with the corrugated peripheral structure in a manner that corresponds to a mating design of the socket 13.

### SUMMARY OF THE INVENTION

Therefore, an object of the present invention is to provide a high torque transmission fastener that is capable of overcoming the aforementioned drawbacks of the prior art.

Another object of the present invention is to provide a socket for use in combination with the aforesaid fastener.

According to one aspect of this invention, a fastener comprises a driven head and a shank portion. The driven head has a top end, a bottom end, a plurality of flat guide surfaces connected between the top and bottom ends, a plurality of angularly spaced-apart rounded driven lobes each connected between two adjacent flat guide surfaces, and a flanged abutment section projecting outwardly and radially from the bottom end. Each of the flat guide surfaces is indented between two adjacent rounded driven lobes. The shank portion is connected to the driven head, and has a thread extending helically around an outer periphery of the shank portion.

According to another aspect of this invention, a socket for use in combination with the fastener of claim 1 comprises a socket body defining a receiving groove to receive therein the driven head of the fastener of claim 1. The receiving groove includes a plurality of flat driving surfaces respectively corresponding in shape to the flat guide surfaces of the driven head so that the flat driving surfaces can engage snugly the flat guide surfaces, and a plurality of angularly spaced-apart rounded driving surfaces respectively corresponding in shape to the rounded driven lobes of the driven head so that the rounded driving surfaces can engage snugly the rounded driven lobes.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a schematic view of a conventional screw;

FIG. 2 is a schematic view of another conventional screw;

FIG. 3 is a schematic top view of the conventional screw of FIG. 1;

FIG. 4 is a schematic top view of the conventional screw of FIG. 2;

FIG. 5 is a schematic view of still another conventional screw;

FIG. 6 is a fragmentary schematic view of yet another conventional screw;

FIG. 7 is a schematic top view of the conventional screw of FIG. 5;

FIG. 8 is a schematic top view of the conventional screw of FIG. 6;

FIG. 9 is a fragmentary schematic view of a further conventional screw;

FIG. 10 is a schematic top view of the conventional screw of FIG. 9;

FIG. 11 is a perspective view of an embodiment of a fastener;

FIG. 12 is a schematic top view of an embodiment of the fastener;

FIG. 13 is a schematic view of another embodiment of the fastener;

FIG. 14 is a view similar to FIG. 13, but illustrating a slightly modified form of another embodiment of the fastener in which an upper face of a flanged abutment section is inclined with respect to a lower face thereof;

FIG. 15 illustrates another form of the fastener;

FIG. 16 illustrates another form of the fastener;

FIG. 17 is a perspective view of another embodiment of the fastener;

FIG. 18 is a schematic view of another embodiment of the fastener;

FIG. 19 is a view similar to FIG. 18, but illustrating a slightly modified form of an embodiment the fastener in which an upper face of a flanged abutment section is inclined with respect to a lower face thereof;

FIG. 20 illustrates another form of the fastener;

FIG. 21 illustrates another form of the fastener;

FIG. 22 is a perspective view of an embodiment of a socket for use in combination with an embodiment of the fastener; and

FIG. 23 is a sectional view taken along line XXIII-XXIII of FIG. 22.

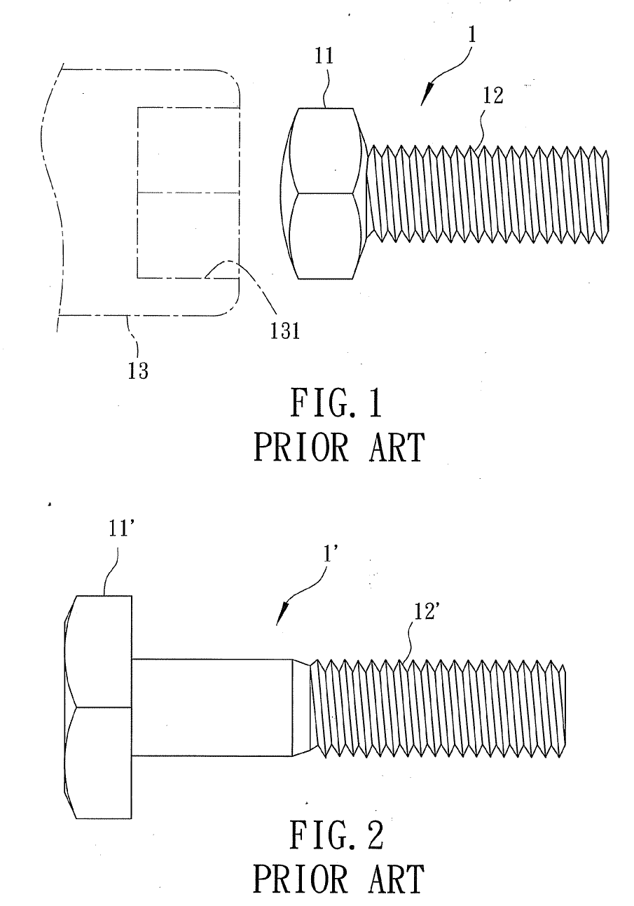

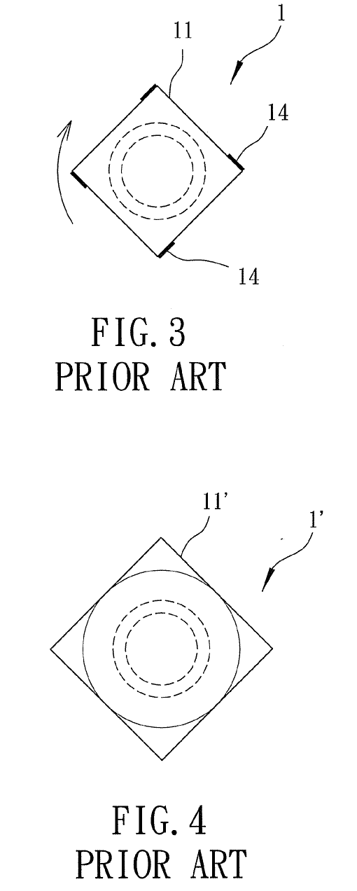

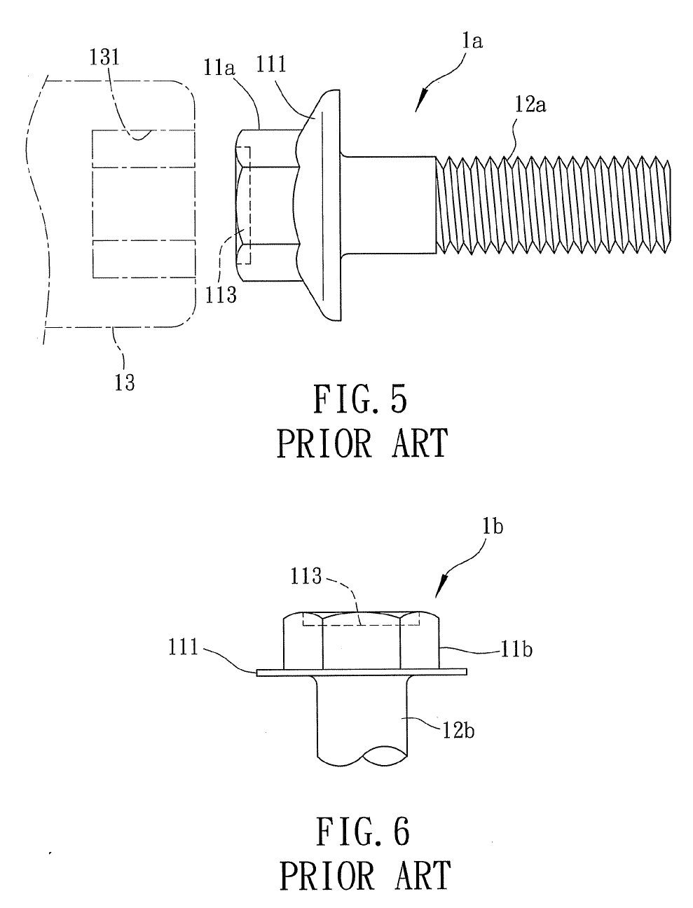

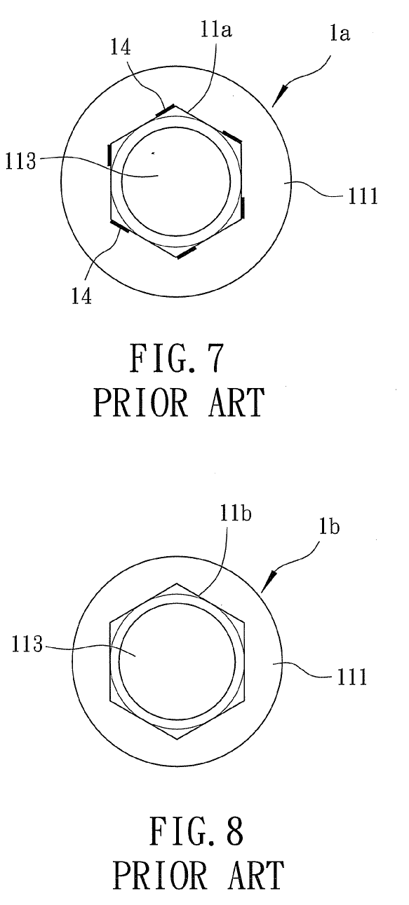

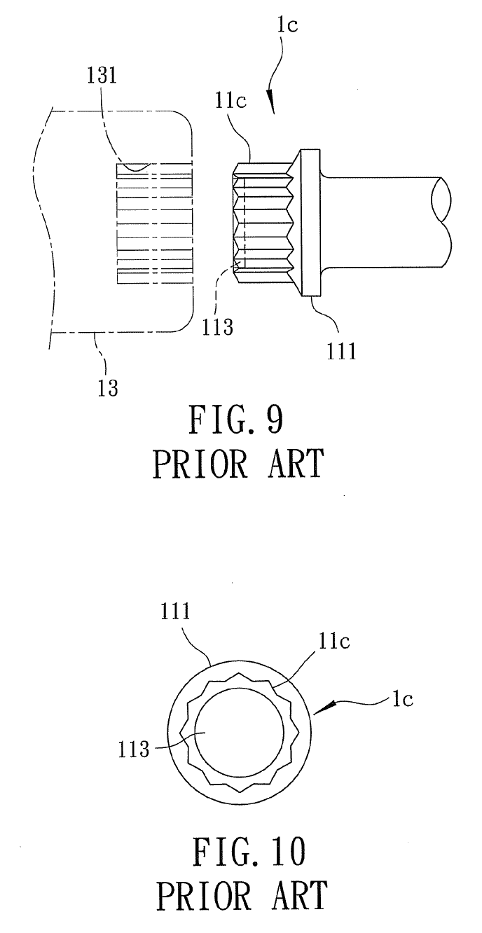

### DETAILED DESCRIPTION

Before the present invention is described in greater detail, it should be noted that the same reference numerals have been used to denote like elements throughout the specification.

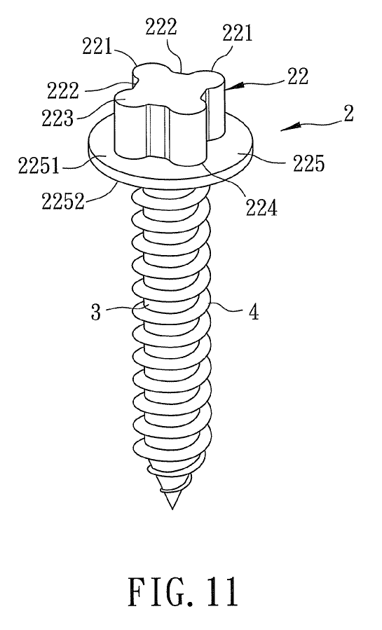

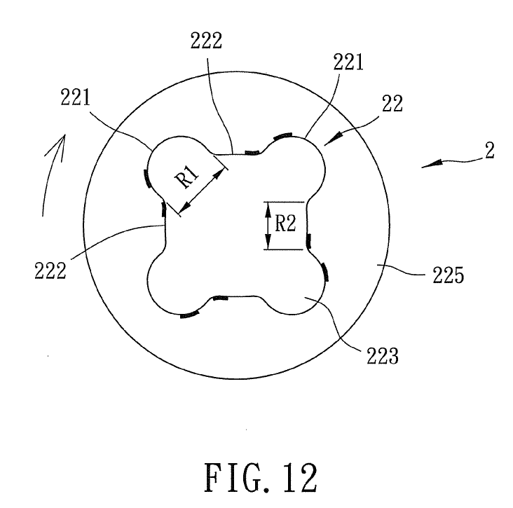

Referring to FIGS. 11 to 13, a fastener 2 according to an embodiment of the present invention is shown to comprise a driven head 22 and a shank portion 3.

The driven head 22 in this embodiment has four flat guide surfaces 222 and four angularly spaced-apart rounded driven lobes 221. Each of the rounded driven lobes 221 is connected between and projects outwardly from two adjacent flat guide surfaces 222. Each of the flat guide surfaces 222 is indented between two adjacent rounded driven lobes 221. Each of the rounded driven lobes 221 forms a semi-circle having a diameter (R1) larger than a length (R2) of each of the flat guide surfaces 222 measured in a direction transverse to an axial direction of the fastener 2. The driven head 22 further has a bottom end 224, a top end 223 with a flat top face, and a flanged abutment section 225 projecting outwardly and radially from the bottom end 224 of the driven head 22, and has opposite upper and lower faces 2251, 2252 that are parallel to each other. In another embodiment, the upper face 2251 may be inclined with respect to the lower face 2252, as shown in FIG. 14.

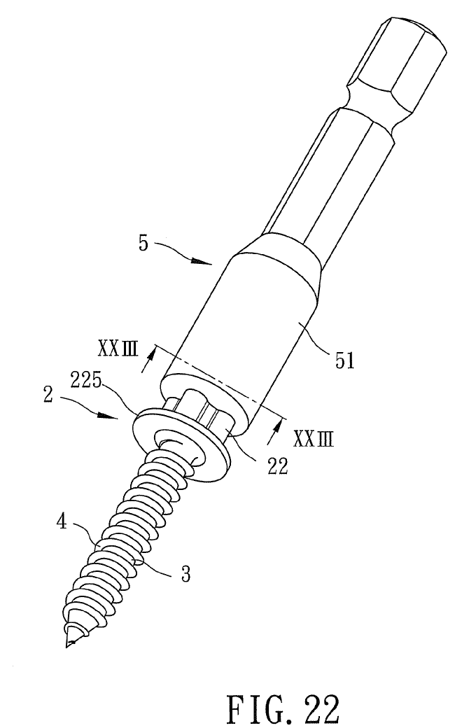

The shank portion 3 is connected to the lower face 2252 of the flanged abutment section 225, and has a thread 4 extending helically around an outer periphery thereof The wearing of corner angles of the driven head 22 is virtually eliminated with the rounded configuration of the rounded driven lobes 221 of the driven head 22. Further, when the fastener 2 and a socket 5 (see FIG. 22) are assembled, through contact of the rounded driven lobes 221 and the flat guide surfaces 222 of the driven head 22 with the socket 5, the well-fitted connection between the fastener 2 and the socket 5 allows maximum torque transmission when the socket 5 drives the fastener 2 to rotate. That is, in some embodiments, this allows the socket 5 to apply more torque to the fastener 2, so that the slippage of the socket 5 when applying a torque to the fastener 2 is not likely to occur.

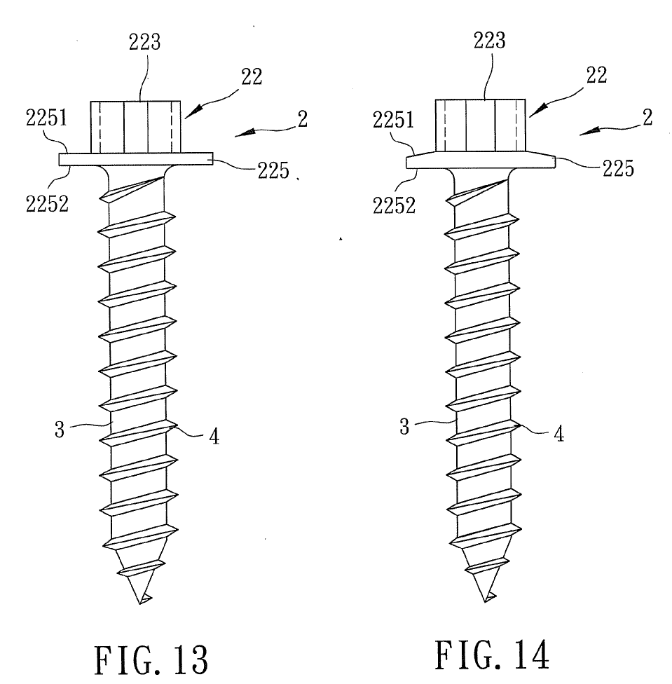

The fastener 2, as shown in FIG. 13, is adapted to fasten different wood and metal plates or components of a machine, and thus produces a drilling hole. Screw manufacturers usually refer to the fastener 2 as a tapping screw. Other forms of the fastener 2 are as follows:

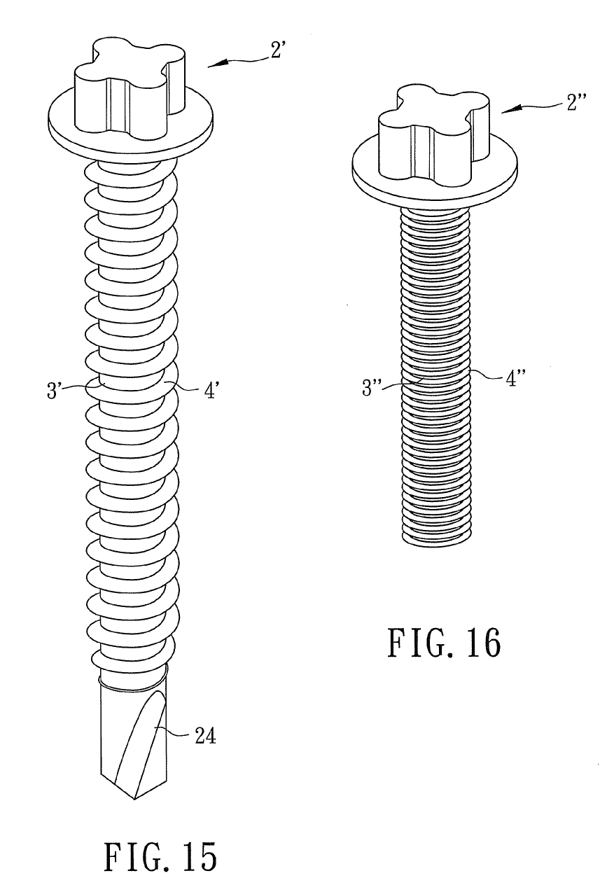

1. Referring to FIG. 15, the fastener 2′ is shown to be similar to the fastener 2. However, with this embodiment, a tip end of the shank portion 3′ is cylindrical, and this tip end is formed with a flute 24. This type of fastener 2′ is often referred to as a self-drilling screw.

2. Referring to FIG. 16, the fastener 2″ is shown to be similar to the fastener 2. However, with this form, the pitch of the thread 4″ is shorter, and the shank portion 3″ has a flat bottom end. This type of fastener 2″ is suitable for use in a metal object which has a pre-formed drilling hole (not shown) with a diameter smaller than an outer diameter of the thread 4″of the fastener 2″. Through such a sturdy construction of the fastener 2″, it can drive threadedly through the drilling hole, and smoothly enter the metal object. Screw manufacturers often refer to this type of fastener 2″ as a machine screw.

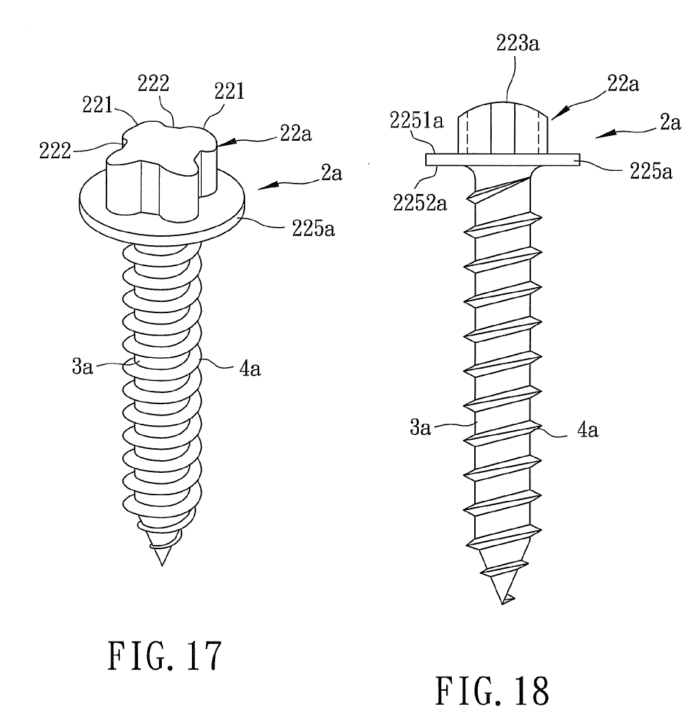

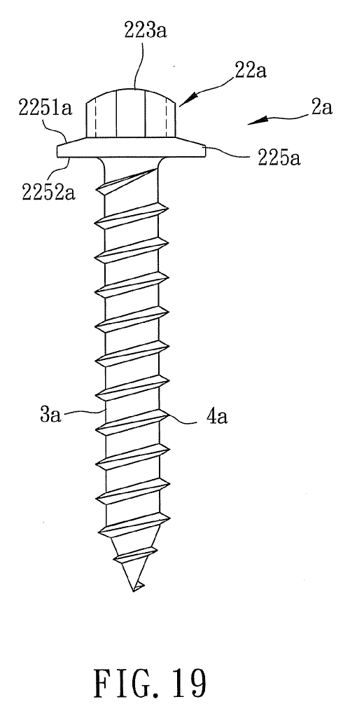

Referring to FIGS. 17 and 18, a fastener (2a) is shown to be similar to fastener 2. However, in this embodiment, the top end (223a) of the driven head (22a) has a convexed top face. The upper and lower faces (2251a, 2252a) of the flanged abutment section (225a) are similarly parallel to each other. In another embodiment, the upper face (2251a) of the flanged abutment section (225a) may be inclined with respect to the lower face (2252a) thereof, as shown in FIG. 19.

Through the configuration of the convexed top face of the driven head (22a), accumulation of rainwater in the driven head (22a) can be prevented and rusting of the fastener (2a) can be avoided, so that the fastener (2a) does not become structurally weak in the long run.

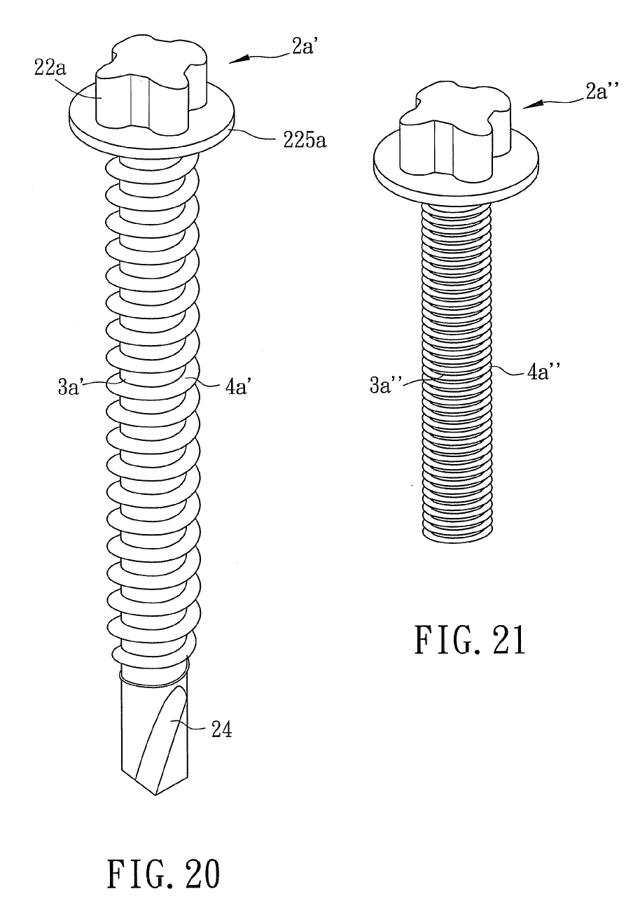

It should be noted that the fastener (2a) may be a self-drilling screw (2a′), as shown in FIG. 20, or a machine screw (2a″), as shown in FIG. 21.

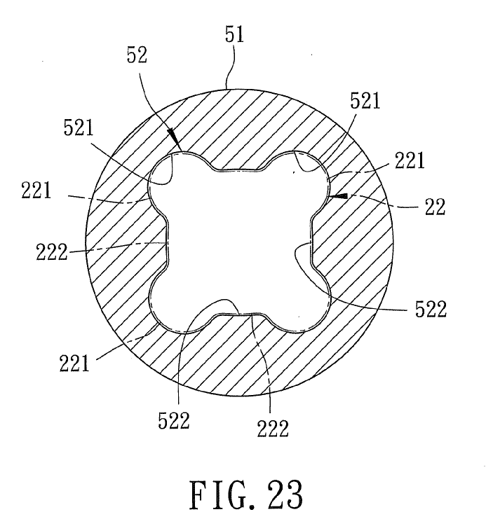

Referring to FIGS. 22 and 23, there is shown a socket 5 that is usable in combination with the fastener 2. The fastener 2 may have a construction similar to that of any embodiments of the fastener described herein. The fastener 2 is shown in FIGS. 22 and 23 by way of example. The socket 5 has a socket body 51 defining a receiving groove 52 adapted to receive the driven head 22 of the fastener 2. The receiving groove 52 includes a plurality of flat driving surfaces 522 respectively corresponding in shape to the flat guide surfaces 222 of the driven head 22 so that the flat driving surfaces 522 can engage snugly the flat guide surfaces 222, and a plurality of angularly spaced-apart rounded driving surfaces 521 respectively corresponding in shape to the rounded driven lobes 221 of the driven head 22 so that the rounded driving surfaces 521 can engage snugly the rounded driven lobes 221. When the driven head 22 is inserted into the receiving groove 52, the socket body 51 abuts against the flanged abutment section 225 of the fastener 2 for subsequent fastening operation.

Due to the presence of the rounded driven lobes 221 and the rounded driving surfaces 521, when the socket 5 is sleeved onto the driven head 22, and applies a torque to rotate the same, the fastener 2 can be easily and accurately fastened to a workpiece. Further, slippage of the socket 5 during a fastening operation is not likely to occur.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

I claim:

1. A fastener comprising:
a driven head having a top end, a bottom end, a plurality of flat guide surfaces connected between said top and bottom ends, a plurality of angularly spaced-apart rounded driven lobes each connected between two adjacent said flat guide surfaces, and a flanged abutment section projecting outwardly and radially from said bottom end, each of said flat guide surfaces being indented between two adjacent said rounded driven lobes; and
a shank portion connected to said driven head and having a thread extending helically around an outer periphery of said shank portion.

2. The fastener of claim 1, wherein said flanged abutment section has a lower face facing said shank portion, and an upper face opposite to said lower face, said lower and upper faces of said flanged abutment section being parallel to each other.

3. The fastener of claim 1, wherein said flanged abutment section has a lower face facing said shank portion, and an upper face opposite to said lower face, said upper face of said flanged abutment section being inclined with respect to said lower face.

4. The fastener of claim 1, wherein each of said rounded driven lobes forms a semi-circle having a diameter larger than a length of each of said flat guide surfaces measured in a direction transverse to an axial direction of said fastener.

5. The fastener of claim 1, wherein said top end of said driven head has a flat top face.

6. The fastener of claim 1, wherein said top end of said driven head has a convexed top face.

7. A socket for use in combination with the fastener of claim 1, comprising:
a socket body defining a receiving groove adapted to receive therein the driven head of the fastener of claim 1, said receiving groove including a plurality of flat driving surfaces respectively corresponding in shape to the flat guide surfaces of the driven head so that said flat driving surfaces can engage snugly the flat guide surfaces, and a plurality of angularly spaced-apart rounded driving surfaces respectively corresponding in shape to the rounded driven lobes of the driven head so that said rounded driving surfaces can engage snugly the rounded driven lobes.
